(19) United States
(12) Patent Application Publication
(10) Pub. No.: US 2019/0200798 A1
(43) Pub. Date: Jul. 4, 2019

(54) Coffee Making Device

(71) Applicant: Manfred Uwe Fleischmann, Chicago, IL (US)

(72) Inventor: Manfred Uwe Fleischmann, Chicago, IL (US)

(21) Appl. No.: 15/857,437

(22) Filed: Dec. 28, 2017

(51) Int. Cl. A47J 31/00; A23F 5/26

(52) U.S. Cl. CPC A47J 31/002; A23F 5/26

(57) ABSTRACT

Disclosed is a coffee making device, comprising a hermetically sealed case, wherein Oxygen in air is widely exchanged to Nitrogen gas and wherein dissolved Oxygen in water, used for brewing coffee, is widely removed and wherein rate of dissolved Nitrogen in said water is increased. Removing Oxygen by flushing Nitrogen gas from a gas cylinder into coffee making device and using diffusers, a faucet-aerator and gas/water pumps to induce diffusion, before brewing of coffee starts in usual way inside coffee making device. Thereafter coffee is stored in widely Oxygen free environment in case of coffee making device, before consumption. An over pressure of approximate 0.3 atm inside coffee making device can be selected to charge water and coffee with nitrogen, simultaneously when removal of Oxygen takes place. A small over-pressure inside case is necessary to prevent any inflow of Oxygen when coffee making device is on.

### CROSS-REFERENCE TO RELATED APPLICATIONS

----

### BACKGROUND OF THE INVENTION

Using this invention, Nitrogen gas is needed. Air already contains about 78% Nitrogen. Nitrogen gas is an inert gas. It is not flammable. Breathing air, not only Oxygen but Nitrogen too passes into the blood using diffusion, but the same amount of Nitrogen leaves blood by lunges using diffusion too. Nitro is dissolved in blood in a constant concentration. But it is not used in our body. Nitrogen in air dilutes Oxygen. 100% Oxygen in air would be toxic. Intake of dissolved Nitrogen by food or by drinking is not dangerous in any way. Dissolved Nitrogen is already in water which is used for drinking or which is used for food. The amount of dissolved Nitrogen in water is very low compared to the amount of Nitrogen in air, having the same Volume. Nitrogen gas has nothing to do with Nitrite in water, which is dangerous for Babies.

Often consumption of coffee takes place much later then brewing of coffee. For example: Suddenly customers want to buy coffee in a coffee shop and this coffee according to high request at 7 a.m. has to be produced before. Often more than an hour earlier. Or suddenly during break between lessons at university, a huge amount of fresh brewed coffee is necessary, which had to be brewed before. Or fresh brewed coffee has to be available at a hotel for hours.

Coffee contains high sensitive aromatic substances. Heated coffee looses aroma and good taste when this coffee is kept hot for a long time before consumption. Oxidation of aromatic substances. is one important reason that best taste and aroma is getting lost after some time. Even coffee beans are often protected of Oxidation. Vacuum packed coffee prevents oxidation of coffee beans. Storing coffee beans, Oxygen and moisture should be prevented.

Oxidation can only take place if Oxygen is available. The Oxygen in water molecule H2O is not available for Oxidation of aromatic substances. Only dissolved Oxygen in water and Oxygen in air is available for oxidation.

Said dissolved Oxygen is in equilibrium to Oxygen in air. So normally inside water there is dissolved Oxygen having a partial pressure of 0.21 in accordance to Oxygen concentration in air. Information available from textbooks of science for example https://www.engineeringtoolbox.com/air-solubility-water-d_639.html.

Or http://www.fondriest.com/environmental-measurements/parameters/water-quality/dissolved-oxygen/#1

For removing Oxygen, Nitrogen gas is already well known to produce non perishable food. Some food is packed in an atmosphere of Nitrogen gas to prevent contact with Oxygen.

Brewed coffee is also available as canned coffee. This canned coffee—as all cans—is often produced several months before consumption. During storage there should be no change in taste and aroma. U.S. Pat. No. 5,384,143, Koyama et al. shows a procedure to remove Oxygen out of canned coffee to keep aroma and good taste. But said patent uses chemical antioxidants like ascorbic acid to prevent oxidation of aromatic substances in canned coffee. Additionally air inside can is exchanged by Nitrogen which is an inert gas as mentioned. By this way Oxygen is removed. This technique is used to produce canned coffee. This procedure removes dissolved Oxygen using chemical substances after brewing coffee, but customers consuming fresh brewed coffee in a coffee shop have the desire to consume coffee without any artificial substances to keep aromatic substances in coffee. Also Coffee making devices as known can't change air by Nitrogen as it is possible in factories producing canned coffee.

There is no known procedure to remove dissolved Oxygen in a coffee making device, without adding artificial substances. There are no devices, which are able to pour out de-oxygenated coffee, meaning coffee wherein dissolved Oxygen is widely reduced. There are procedures available to produce Nitrogen charged coffee. Either by making a cold brew coffee which is charged with Nitrogen or by brewing coffee with hot water in usual way and charging this coffee with Nitrogen thereafter. For example essay: A new trend in serving cold brew coffee uses science to make it more delicious, Tech insider, author Julia Calderone, Aug. 24, 2015, 3:05 PM

Nitrogen has the effect to make a creamy coffee, tasting sweet in some way. There are procedures described to introduce Nitrogen for some seconds in a keg containing coffee while a valve is open that air can leave keg, then the valve is closed and high pressure nitrogen is introduced in keg. But these procedure for example is lacking the ability to brew coffee within a nearly Oxygen free environment to avoid oxidation of coffee during brewing and also introducing nitrogen in a keg for some seconds while a valve is open will not remove most oxygen out of air and will not remove most of dissolved oxygen out of coffee. Also Oxidation has already started during brewing.

Fresh brewed coffee is hot and heat speeds up any chemical reaction. Oxidation is a chemical reaction. So a process of brewing coffee is needed which reduces oxidation of aromatic substances in coffee, just starting at the time when coffee is brewed and continuing till coffee is consumed, having the effect to keep quality of coffee for a longer time, leading to a higher consumer satisfaction and saving money while coffee having a good taste is available for a longer time.

Nitrogen which is put into a gas cylinder was taken out of air and this Nitrogen will be let to air again after consumption of coffee. So using Nitrogen for removing Oxygen does not produce pollution of environment.

As described, purging water with Nitrogen is a very effective method for widely removing Oxygen out of water. A concentration of 0.2-0.4 ppm of Oxygen was found after purging for 20-40 min with nitrogen remove described in an essay, title: Removing of dissolved oxygen from water, a comparison of 4 common techniques mar Pub med 1994 author I Butler and D rickard,

### BRIEF SUMMARY OF THE INVENTION

It is the object of the present invention to provide a process for brewing coffee in a mostly Oxygen free environment wherein air inside coffee making device containing about 78% Nitrogen and 21% Oxygen is widely exchanged to air having nearly 0% Oxygen but nearly 100% Nitrogen minus percent rate of water vapor in air and wherein dissolved Oxygen in water to be used for brewing coffee is widely removed too and wherein Nitrogen can charged in water additionally. By this way partial pressure of Nitrogen in water is increased from 0.78 as usual to a much higher level. By this way a widely de-oxygenated coffee is produced. The process of removing Oxygen takes place inside the coffee making device, having a hermetically sealed case. There is an inflow of Nitrogen in case, said Nitrogen is mixed with air inside case and said Nitrogen is introduced in water of water container inside case to be used for brewing coffee at a later time.

Oxygen is removed out of water by using a Diffuser, which is introducing Nitrogen bubbles in water. These bubbles support diffusion of dissolved Oxygen out of water into Nitrogen bubbles, which finally appear on the surface of water. Additionally there are electric pumps inside case to speed up diffusion and to save Nitrogen. A water pump pumps water out of water container to a faucet-aerator which is installed above water level of water container. Aerators are well known but this aerator works in the opposite way. Removing Oxygen. Water drops out of faucet-aerator get in contact to air inside case, which contains less and less Oxygen because of permanent inflow of Nitrogen in case. In this way diffusion, removing Oxygen out of water into air inside case takes place.

A gas pump pumps air out of case in water of water container, using another diffuser. In this way diffusion is supported. Another gas pump pumps air out of case in empty coffee container to mix air inside coffee container with air inside case.

Another gas pump pumps air out of case in tubes which are used at a later time to pump hot water out of coffee container into filter for coffee. By this way, air inside said tubes is exchanged with air inside case. All pumps and all other electric devices are controlled by an electronic control, having a time control. During inflow of Nitrogen, every 3 min. an amount of Nitrogen, equal to amount of air inside case is let inside case as selected and simultaneously the same amount of nitrogen-Oxygen mixture is let out of case. Theoretically every 3 min. the concentration of Oxygen inside case is half the size then before, leading to a calculated Oxygen concentration of 0.16% after 21 min. and to a similar reduction of dissolved Oxygen in water, because of said process to induce diffusion. Time for mixing air with Nitrogen is adjustable.

At the end of this process, removing Oxygen out of air and inducing diffusion in water, gas supply of nitrogen is stopped and said electric pumps are turned off. Then water is heated to 91 degrees Celsius. By this way dissolved Oxygen and nitrogen in water is reduced additionally, because of lower gas solubility in heated water. Then, inflow of Nitrogen is turned on again for 2 min, removing Oxygen again, electrical pumps are not turned on again. Then supply of Nitrogen is stopped again and brewing of coffee starts in a second step in a well known way, while using a filter, already filled with ground coffee and using this mostly Oxygen free hot water. A hot water pump pumps hot water into filter. Using a electric pump, coffee is let out of case on request.

the advantage of this invention is: these high sensitive aromatic substances in filtered coffee are not in contact with the same amount of Oxygen as usual, but are only in contact with a highly reduced amount of Oxygen. So oxidation of aromatic substances—the enemy of every coffee—can't take place as usual, because main substrate of oxidation-Oxygen is not available as usual. Dissolved Oxygen is mainly reduced in water, having the result that the taste of the brewed coffee is very good for a long time. Often it is necessary to brew coffee hours before consumption takes place. Even the invention uses Nitrogen, it is not necessary that the coffee is a Nitrogen charged coffee as usual. Only a small over pressure inside coffee making device is necessary to use said coffee making device to avoid that leaks lead to an inflow of air containing Oxygen. A minimal over pressure of 0.1 atm is possible. This overpressure can be adjusted using an over pressure valve at outlet of air. But an over-pressure of 0.3 atm is recommended. Then the water is charged with an over-pressure of 0.3 atm and finally the brewed coffee has an over-pressure of 0.3 atm Nitrogen too. But this is not a integral constituent of this invention. This invention stresses in Oxygen reduction of water, of air inside coffee making device and of Coffee. After Nitrogen inflow has started, the pressure inside case is increasing till selected pressure is reached. After reaching selected pressure level, air containing Oxygen can leave case using over-pressure valve.

### LISTING OF FIGURES

### Brief Description of the Several Views of the Drawings

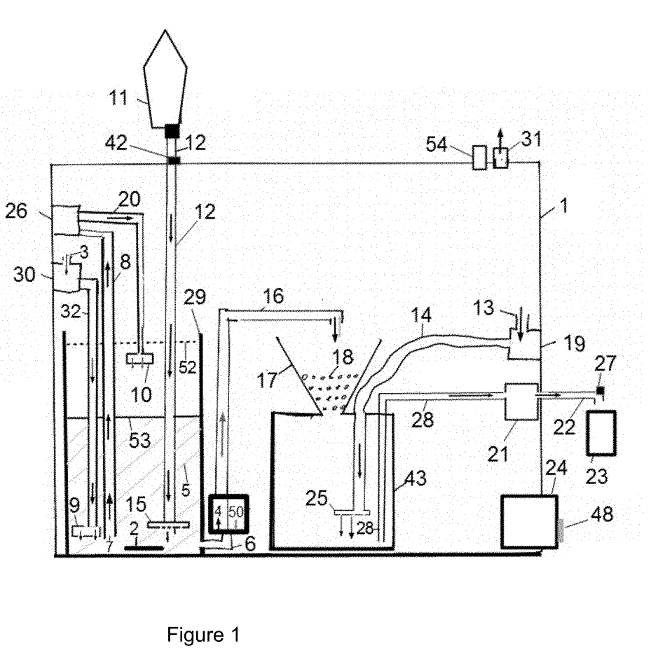

FIG. 1 shows a 2D front view of the coffee making device, all parts are shown schematically,

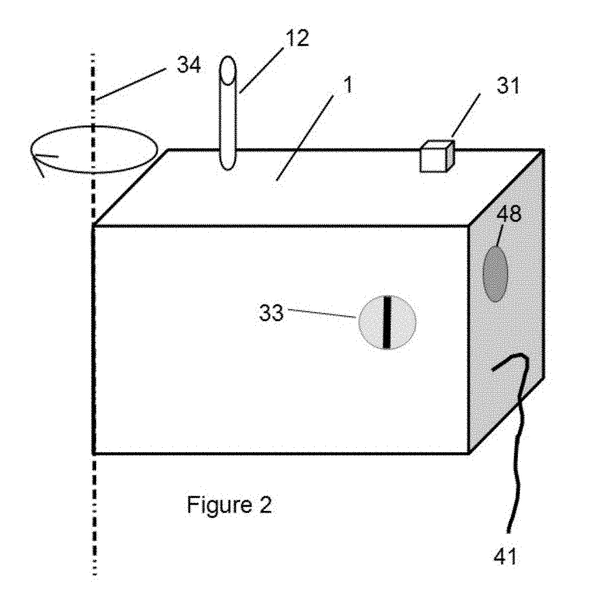

FIG. 2 shows a 3 D view of the case of the coffee making device, showing in which way opening flap can be opened

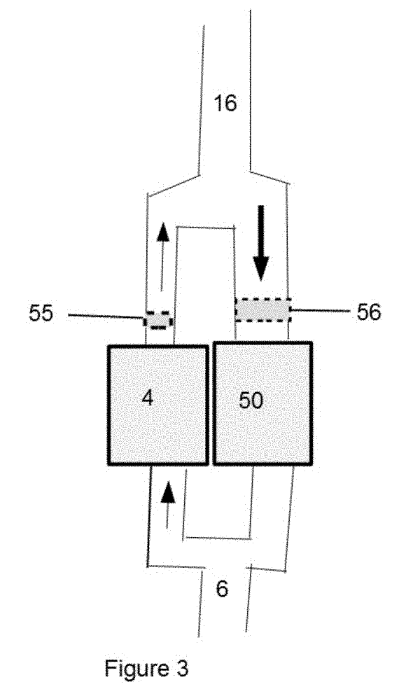

FIG. 3 shows water pump 4 and gas pump 50 schematically, which both are using 2 tubes at different times.

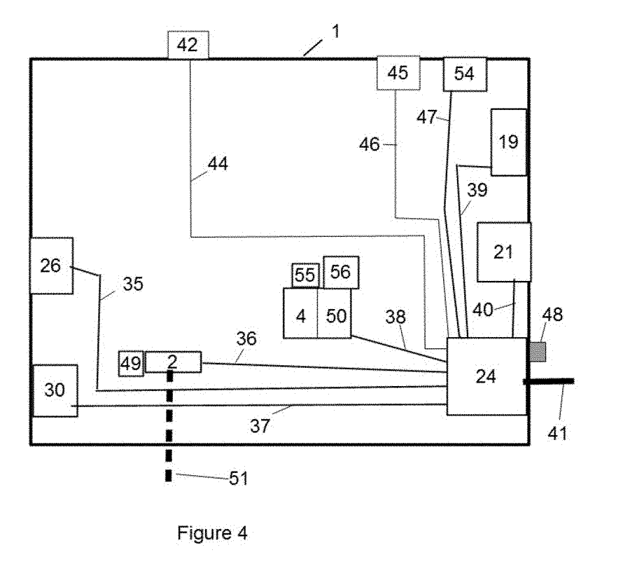

FIG. 4 shows connection of electric devices with electronic control of coffee making device schematically

Names of parts represented by numbers in the drawings, the number is always listed first, name is listed second. Then there is a comma or a period and the number of next item is shown

1 case, 2 heater for water, 3 suction and inlet for nitrogen oxygen mixture, 4 electric water pump pumping heated water to coffee filter, 5 water in water container, 6 tube for water leading to electric water pump for filtering coffee, 7 Suction and water inlet leading to water pump, 8 tube for water leading to the electric water pump, 9 diffuser for nitrogen-oxygen mixture, 10 faucet aerator, 11 Gas cylinder containing nitrogen, having a valve and having an adjustable flow rate regulator, 12 tube for Nitrogen leading to the water container, 13 suction and air inlet leading to electric gas pump, 14 tube for nitrogen/oxygen mixture leading to coffee container, 15 diffuser for Nitrogen, 16 tube for water leading to the coffee filter, 17 coffee filter, 18 Ground coffee, 19 electric gas pump, 20 tube for water leading to faucet above water level, 21 electrical coffee pump, 22 tube for coffee leading to the outlet for coffee, 23 coffee pot, 24 Electronic control of the machine, 25 outlet for Nitrogen oxygen mixture, 26 electric water pump, 27 outlet for coffee having a spigot, 28 tube for coffee leading to coffee pump, 29 water container, 30 electric gas pump, 31 outlet of air out of case having an adjustable over-pressure valve, 32 tube for nitrogen/oxygen mixture leading to water container, 33 handle of opening flap, 34 axis of rotation, 35 power supply and control line for electric water pump, 36 control line for heater and signal of temperature sensor, 37 power supply and control line for electric gas pump, 38 power supply and control line for electric water pump 4, for gas pump 50, for Electromagnetic opening valve 55 at outlet of water pump Number 4. and for Electromagnetic opening valve 56 at the inflow of gas pump number 50, 39 power supply and control line for electric gas pump, 40 power supply and control line for electric coffee pump, 41 power supply 110V/220V for electronic control of machine and for electricity consumers in machine, 42 Electrically controlled opening valve for Nitrogen, 43 coffee container, 44 power supply of Electrically controlled opening valve for Nitrogen, 45 manometer, 46 control line for signal of manometer, 47 control line for electromagnetic opening valve, 48 switch to turn on/off coffee making device, switch to turn on/off coffee pump, indicator lamp showing when coffee is brewed and adjustable time controls of electronic control 49 temperature sensor, 50 electric gas pump, 51 power supply for heater 110V/220V, 52 cover of water container, 53 water level, 54 Electromagnetic opening valve for air at out-flow out of case, 55 Electromagnetic opening valve at outlet of water pump Number 4. 56 shows Electromagnetic opening valve at the inflow of gas pump 50

### DESCRIPTION

Using this invention, Brewing of coffee takes place inside the environment of the coffee making device. Oxygen in air and dissolved Oxygen in water inside coffee making device is changed to Nitrogen. So this invention makes it possible to brew coffee in an environment having high reduced Oxygen meaning nearly no Oxygen, than if brewed in an atmosphere of air as usual and using water containing dissolved Oxygen as usual and using water having contact to air during brewing of coffee. Using this invention, concentration of Oxygen in air inside coffee making device is widely reduced but also concentration of dissolved Oxygen in water for making coffee, but also concentration of dissolved Oxygen in fresh brewed coffee at a later time, leading to a massive reduced ability to oxidate sensitive aromatic substances in coffee during brewing and after brewing, before coffee is poured out. Because oxidation of aromatic substances is a destruction of aromatic substances, downgrading taste, using this invention leads to a higher quality and better taste of coffee, especially in cases when coffee has to be kept hot for a while before consumption starts.

There are inventions reducing dissolved Oxygen in coffee by adding chemical substances like ascorbic acid. This process is used to produce canned coffee. But there is no process described to remove dissolved Oxygen by using Nitrogen. Consumers have a desire to drink a fresh brewed coffee in which no artificial chemical substances, having no taste by themselves are added. Air already contains 78% Nitrogen. So the benefit of this invention is on the one hand, widely removing dissolved Oxygen in water already before brewing starts, reducing ability to oxidate aromatic substances not after brewing but already before, producing fresh brewed coffee and keeping this coffee in a nearly Oxygen free environment before consumption and on the other hand, doing this without using new artificial substances, which have nothing to do with coffee, but using Nitrogen gas which is already main component of air and which is already dissolved in water.

Charging coffee with nitrogen, meaning adding Nitrogen under a higher pressure then atmospheric pressure is possible but it is not a substantial part of this invention. But when the process of brewing coffee as described in this invention takes place under conditions of a higher pressure then atmospheric pressure, for example 0.3 atm, then the produced Deoxygenated Coffee is a Nitrogen charged coffee too.

But a low over pressure inside coffee making device for example 0.1 atm is always necessary to inhibit inflow of Oxygen using leaks. But this over process does not produce nitrogen charged coffee meaning hypersaturation of water and coffee with Nitrogen gas. Percent-rate changes in amount of dissolved Nitrogen gas in water or coffee caused by 0.1 atm, 10% of atmospheric gas pressure, are too low to speak of Nitrogen charged coffee.

There are inventions charging coffee with Nitrogen, especially charging kegs containing cold brewed coffee with high pressure Nitrogen. But removing Oxygen out of water or removing Oxygen out of coffee is not a part of these inventions.

Normally Oxygen is dissolved in water. This dissolved Oxygen does not have to do with bond Oxygen in water molecules having chemical formula H2O. Even some water molecules dissociate, but the result is a positive H₃0+Ion and a OH— Ion, not O₂. This effect is depending on PH value of water. Dissolved Oxygen is non chemically bond Oxygen like CO2 in carbonated water. In rivers dissolved Oxygen is produces by plants for example. Dissolved Oxygen is Oxygen that is not bonded to any other element. Amount of dissolved Oxygen and dissolved Nitrogen in water as usual can be calculated. Normally there is an equilibrium of partial pressure of gas in air and dissolved gas in water. This invention uses Nitrogen bubbles to remove dissolved—Oxygen out of water. But also a faucet aerator is used to induce Diffusion. Bubbling Nitrogen in fluids using diffusers is a well know effective process to remove dissolved Oxygen out of this fluid. Faucet aerators are used to bring water in contact to gas and to induce Diffusion.

Calculation of Dissolved Nitrogen and Oxygen in water. According to Henry's law: D=(p/S)×MW. D=Dissolved Nitrogen gas concentration in water. p=partial pressure of Nitrogen. S=solubility of Nitrogen in water per mol). MW=molar weight in g/mol D=[1 atm×0.79%]/[1600 atm/(mol/litre)]×(28.01 g/mol)=0.0138 g/liter=13.8 mg/liter. Formula in Sheet 5.

At water temperature of 25 degrees Celsius in air without over pressure. Having 13.8 mg dissolved Nitrogen in water at 25 degrees Celsius and using air having partial pressure of Nitrogen 0.78 it is possible to increase dissolved Nitrogen in water using diffusion to 100% Nitrogen. By this way (13.8 mg/78)×100=17.7 mg dissolved Nitrogen in water is possible without increasing gas pressure. Increasing gas pressure inside case to 0.1 atm would increase dissolved Nitrogen in water to 10% additionally, because air pressure is 1 atm. Increasing gas pressure to 0.3 atm would increase dissolved Nitrogen to 30%.

According to Henrys law concentration of dissolved Oxygen in water can be calculated too. Solubility Oxygen—O₂: 756.7 atm/(mol/litre), Molar Weights Oxygen—O₂: 31.9988 g/mol, Partial fraction in Air Oxygen—O₂: ˜0.21. at a temperature of 25° C. So concentration of Oxygen in water in accordance to Henry Law's is 0.0089 g/liter=8.9 milligramm Oxygen/liter using water at atmospheric pressure and a temperature of 25 degrees Celsius

Solubility for Oxygen is higher then solubility for Nitrogen. Volume of said 8.9 mg Oxygen/liter water can be calculated approximately using formula for density of Oxygen at 20 degrees Celsius and air pressure of 1 atm 1013 mbar. Density of Oxygen=1.33 kg/m3=1.33 g/liter=1,330 mg/I. Density of air having 30 degrees Celsius is about 6% lower then air having 20 degrees Celsius. So density of Oxygen having 25 degrees Celsius will be about 3% lower then density of air having 20 degrees. So comparing approximated volume to real volume, real volume will differ for about 3%, which is irrelevant.

So these 8.9 mg Oxygen per liter have a Volume of approximately 6.69 ml Oxygen per liter water, rounded 7 ml Oxygen per liter water. This invention widely removes these 7 ml Oxygen per liter water and widely removes Oxygen out of case of coffee making device. Even there might be some ml Oxygen in air inside case, this amount of Oxygen or an important percent rate of this amount is not able to dissolve in water because Partial pressure of Oxygen in case is very low after bubbling Nitrogen in water and a possible re-diffusion of Oxygen in water is dependent on partial pressure of Oxygen in air. So this widely reduced partial pressure of Oxygen inside case is a protection against re-diffusion of Oxygen in water even there might have stayed some ml Oxygen inside case.

Using this coffee making device, coffee is produced in two I steps. In a first step: Nitrogen is introduced in water of water container 29 of coffee making device using a diffuser. This inflow of Nitrogen produces small bubbles which escape upwards. By this way Diffusion takes place and time by time most part of Oxygen is removed out of water, which is used for brewing coffee at a later time These Nitrogen-bubbles are reaching surface of water and finally Nitrogen in bubbles is mixed with air in case. By this way air inside case of coffee machine is exchanged with a Nitrogen-Oxygen mixture So percent rate of Nitrogen inside case 1 is increased, minute for minute. But vice versa percent rate of Oxygen is decreased minute by minute by dilution. Inflow of Nitrogen also leads to an increase of gas pressure inside case. When gas pressure inside case is higher then adjusted pressure using over-pressure valve, over-pressure valve opens for a short time and excessive nitrogen-oxygen mixture leaves case till pressure inside case is as high as adjusted. Coffee making device is working in an environment of higher gas pressure then atmospheric gas pressure. If over-pressure is low, produced coffee is not a Nitrogen-charged coffee. If over-pressure is 0.3 atm, then the produced deoxygenated coffee is also a Nitrogen-charged coffee, as a side effect which is wanted. Additionally to Nitrogen inflow in water, water gets in contact with Nitrogen-oxygen mixture inside case by use of a faucet-aerator. Additionally Nitrogen-oxygen mixture inside case is pumped in water of water container 29 using a gas pump and another Diffuser. So diffusion of Nitrogen in water and diffusion of Oxygen out of water is speed up. A water pump pumps water to a faucet aerator above water level 53 to support diffusion

Another gas pump mixes Nitrogen-Oxygen mixture inside case. Another gas pump introduces Nitrogen-oxygen mixture out of case inside tubes which are used for pumping hot water at a later time. By this way air containing Oxygen is removed out of tube. All electric pumps which are used are mini diaphragm pumps, which don't need lubrication. After an adjusted time has passed, 21 min is recommended, dissolved Oxygen in water and Oxygen in case will be removed widely. Electronic control 24 turns off all pumps after this time has been reached and heater inside water container is turned on, heating water to 91 degrees. Temperature sensor in water container 29 gives signal to electronic control 24 and heater is turned off by electronic control 24. Heating water decreases solubility for dissolved gas. After water has been heated up, electronic control 24 turns on inflow of Nitrogen again for 2 minutes, to remove Oxygen out of case again. If water temperature is lower then 90 degrees Celsius caused by introducing gas in water leading to water vapor and cooling down water, then heater is turned on again till 91 degrees Celsius are reached again. After these 2 min as mentioned above, Nitrogen inflow stops and second step starts.

The second step is brewing of coffee in a well known way, using this mostly Oxygen free hot water and a filter. Hot water pump is turned on, pumping hot water in filter of coffee making The difference to the usual technique is that these high sensitive aromatic substances in filtered coffee are not in contact with the same amount of Oxygen as usual but are only in contact with a highly reduced amount of Oxygen. So oxidation of aromatic substances, downgrading taste of coffee, can't take place as usual. because main substrate of oxidation-Oxygen is not more available as before. The result is that the taste of the brewed coffee is very good for a long time. Often fresh brewed coffee is not consumed at once, stays hot and meanwhile oxidation of aromatic substances takes place. This oxidation is now massive reduced because lack of Oxygen. In lack of main substrat chemical reactions are massive slowed down or impossible. Additionally, if an over pressure of 0.3 atm was chosen in step 1, the brewed coffee is a de-oxygenated, Nitrogen-charged coffee, charged with 0.3 atm Nitrogen. Charging coffee with Nitrogen improves taste of coffee too. If an over-pressure of 0.1 atm was chosen, the produced coffee cant be seen as a Nitrogen charged coffee but it is a de-oxygenated coffee as described in this invention. Turning off and turning on of electric pumps is time controlled by electronic control.

FIG. 1 a schematic front view of coffee-making-device showing parts of coffee making device and showing how these parts are connected

The coffee machine has a case 1. Inside the case there are two containers. The water container 29 and the coffee container 43. The case has internal dimension of 400 mm×200 mm×350 mm (width×depth×height)=28,000,000 mm³. This means case has a volume of 28 liter. Case is made of steel having a wall thickness of 10 mm or another material, which is able to resist against a pressure of 0.7. atm for example Perspex. Now using steel having a wall thickness of 10 mm, external dimension of case is 410 mm×210 mm×360 mm (width×depth×height). After starting the coffee machine, there can be a rise in pressure inside case of coffee making device to 0.3 atm, but at least to 0.1 atm as adjusted. So for security reasons material is used which can resist against a pressure of 0.7 atm.

The size of water container 29, made of plastics is 150 mm×150 mm×250 mm (width×depth×height). So capacity of water container 29 is 5.62 liter. Because of wall thickness real capacity is lower. Water container is filled with 4 liter of water 5. So water level 53 is about 17.8 cm when water container is filled with 4 liter of water. Calculation:150 mm×150 mm×178 mm=4.0 liter (width×depth×height of water). Water container 29 has a cover 52. Openings allow tubes to lead in water container 29. The cover 52 prevents water of spurting out while Nitrogen is infused in water. The faucet aerator 10 is in water container but definitely above water level 53 and faucet aerator 10 is not covered with water.5

Size of Coffee container 43 is 150 mm×150 mm×230 mm (width×depth×height). So volume of coffee container is 5.4 liter. Wall of Coffee container has a 10 mm isolation against loss of temperature. So inner volume is 140 mm×140 mm×300 mm (width×depth×height). So 4.5 liter of coffee can be filled in coffee container. But only about 1 gallon coffee is brewed, because a part of these 4 liter water in water container is vaporized during water is deoxygenated and water is heated up. To get an excellent taste, filtering of coffee should not take longer then 5 min. So water pump 4 pumps 4 liter of water within 4 minutes. Normally within 30 seconds all water which is in filter is running through filter. After 5 minutes filtering is finished usually.

There are different electric pumps inside case. All of these pumps are able to pump water or air. These pumps are using 6, 9, or 12 Volt DC. Three pumps for air: 9, 30 and 50. electric gas pump 19 pumps nitrogen-Oxygen mixture in empty coffee container to mix this air and to increase Nitrogen concentration. Pump output is about 4 liter/min. Electric gas pump 30 introduces Nitrogen-Oxygen mixture in water container to support diffusion. Pump output is about 4 liter/min. Electric gas pump 50 pumps Nitrogen-Oxygen mixture in tube 16 to reduce Oxygen concentration in this tube as long as hot water is not pumped to filter. Pump output is about 1 liter/min. Three pumps for water are inside the case: pump 21, 4, and 26. electric water pump 4 pumps heated water to filter Pump output is about 1 liter/min, electric coffee pump 21 is needed to pour out coffee, Pump output is about 2 liter/min. Electric water pump 26 pumps water to faucet-aerator to reduce Oxygen in water. Pump output is about 3 liter/min. Output of all pumps is adjusted as mentioned above by reducing Voltage or by reduction of the cross-sectional area at the area of the outflow of the pump. Adjusting outflow takes place when coffee making device is made.

Different Diffusers can be used. For example: Diffuser easy pro rad 4 EPDM rubber membrane air diffuser 4 inches “long max airflow 0.1 cfm=281/min recommended flow 0.2 cfm available at Amazon. Their diameter is about 1 quarter of the length. So both diffusers can be put into water container side by side. These Diffusers are build for an aquarium to introduce Oxygen, but now vice versa Nitrogen is introduced Tubes are made of plastic which can be used for beverages. Pumps are mini diaphragm pumps, available at Amazon. A Faucet aerator for a sink as available at Amazon is used, for example, LDR 530 2100 Standard Lead Free Female Aerator, 15/16-Inch×55/64-Inch×27-Inch, available at Amazon. The aerator is connected to tube 20 using a connector, which can be made in an easy way.

There is an Electronic control of the coffee making device. 24. This control has switches, an indicator lamp and a time controls of electronic control, 48. In detail there is an, on/off switch for electronic control, an on/off switch for coffee pump, an adjustable time control and an indicator lamp. In the drawing all these 2 switches, the adjustable time control and the indicator lamp are figured together named 48, because they are positioned close together. But also a touchscreen showing these 2 switches, on/off switch for device and on/off switch for coffee pump and showing indicator lamp on display and having an adjustable time control by using touchscreen to adjust, can be used. So there is only one number-number 48—for these 4 items. All said switches and time control are adjustable and visible from outside. Indicator lamp can be seen from outside. Device does not have to be opened to make adjustments or to see indicator lamp. A power supply of 110V/220V is leading to the electronic control. Adjustable time control is making adjustment how long there will be an inflow of Nitrogen and, by this way, how long pumps are working. The time for mixing Nitrogen to water and for reducing Oxygen concentration by this way is controllable. 21 min is recommended. The longer the adjusted time, the more Oxygen will be removed. But this needs more time and more Nitrogen. Using this coffee making device every 3 min Oxygen concentration In air inside device is decreased for approximately 50% in comparison to the value of the last 3 min. interval. Meaning 21%-10.5%-5.25% and so on every 3 min

A Thermostat control maintains water temperature at 196 Fahrenheit, 91 degrees Celsius after heating of water is finished and before hot water pump is activated to filter coffee. In the time sequence mentioned below, electric pumps, heater and supply of Nitrogen gas, are switched on and off. After mixing Nitrogen to water during selected time, Nitrogen supply is turned off by electronic control 24. Then water is heated up to 91 degrees Celsius using heater 2. Then Nitrogen supply is turned on again for 2 min. If temperature of water gets lower then 91 degrees Celsius, heater is turned on again by electronic control. Beside heater there is a temperature sensor 2. After said 2 min, introducing Nitrogen again, Nitrogen supply is turned off again. Heater 2 will not be turned on anymore and hot water pump 4 is started to pump hot water into filter within 4 minutes. After 5 min. hot water pump is turned off and indicator lamp 48 is turned on showing that coffee has been brewed. Turning on switch for coffee pump and opening spigot 27 will serve coffee. Coffee can be stored inside case for several hours. Coffee container has a temperature—isolation The over-pressure inside case is low-0.1-0.3 atm as adjusted. So an electric coffee pump 21 is needed, too, to serve coffee out of coffee container.

Due to leaks, pressure inside case can decrease, but electronic control turns on Nitrogen supply again for 3 min if pressure inside case 1 is lower then 0.1 atm. Pressure inside case is registered by manometer 45. Manometer 45 is connected with electronic control by control line for signal of manometer 46. An inflow of 3 min are sufficient to bring pressure inside case to a level of 0.3 atm if an over pressure of 0.3 atm was selected. Within 3 min., pressure inside case would be about 1 atm if there would be no over-pressure valve. Introducing Nitrogen again, the pressure inside case will not be higher then selected adjusted pressure using adjustable over pressure valve at outlet of air 32. A manometer 45 and a temperature sensor 49 inside water container are leading Information to electronic control. If pressure inside case is higher then 0.5 atm for any reason, then electronic control turns off Nitrogen supply and device is turned off for security reasons. Electromagnetic opening valve for air at out-flow out of case 54 is opened and pressure is reduced.

A electronic module available from companies is used for electronic control. In an easy way all necessary functions can be programmed in a way that coffee making device and all electric devices inside case are working in the same way as mentioned. The module works in a way to start pumps, to stop pumps, to open electromagnetic valves, to torn on an indicator lamp, to close electromagnetic valves, to receive information about pressure and tempererature and to turn on turn off pumps, valves etc in the way as it is described. Modules which can be programmed in this way are available. Programming has to be made according to rules shown in description.

The coffee making device has the effect to reduce Oxygen concentration before brewing coffee. The amount of Oxygen in the air of case can be calculated. The amount of Oxygen in water has been mentioned before. Water container is filled with 4 liter, so there are 4×7 ml Oxygen=28 ml Oxygen in water before coffee making device has started.

Volume of case containing water container, coffee container, pumps, tubes, electric cables, heater is 400 mm×200 mm×350 mm (width×depth×height).=28 liter as mentioned above. Water volume in water container is 4 liter. So air in case is about 281-4 liter=24 liter. In fact volume is lower because pumps wires etc have a volume too. Percent rate of Oxygen is 0.21. 24×0.21=5.04. So there are maximal 5.04 liter Oxygen inside case 1.

This coffee making device is a Prototype. It will be possible to construct coffee making devices using this technique, having a much lower volume of air in case. By this way less Nitrogen will be needed to reduce partial pressure of Oxygen in air inside case and in water.

After starting Nitrogen supply, flow of nitrogen is 8 liter per minute. Nitrogen flow is adjustable using xx. So After 3 minutes there will be a flow of 24 liter Nitrogen inside case. These 24 liter of 100% Nitrogen are mixed with 24 liter of air inside case, already containing 78% Nitrogen and 21% Oxygen. So Oxygen concentration is reduced by 50% from 21% to 10.5%. after 3 minutes under ideal circumstances. Nitrogen gas concentration is increased from 78% to 89.5%, by mixing same amounts of gas having 100% Nitrogen with 78% Nitrogen.

After starting Nitrogen supply, percent rate of gas in case is changing. So for this reason the air in case is now called “Nitrogen-Oxygen-mixture”, expressing that Nitrogen concentration had been increased and Oxygen concentration had bee decreased. When adjusted pressure is reached, while introducing Nitrogen, Over-pressure valve opens and there is an outflow of Nitrogen-Oxygen-mixture till adjusted pressure is reached again After next 3 minutes Oxygen concentration is again 50% lower then before 100% Nitrogen was mixed with 89.5% Nitrogen in nitrogen-Oxygen mixture. Deviations are possible in case there is no complete mixing of Nitrogen.

After 21 min which is 7 times×3 min, Oxygen concentration in case is reduced to 21%×(0.5)⁷=0.16%.

Deviations are possible, but definitely concentration of Oxygen is massively reduced. After heating up water, there is also a high amount of water vapor in Nitrogen-oxygen mixture, reducing percent rate of oxygen in nitrogen-oxygen-mixture inside case additionally. Using another calculation using 3 sec intervals, while adding 400 ml Nitrogen into case within 3 sec. (81/min as mentioned before) and removing 200 ml air out of case, while always mixing Nitrogen to air, calculated amounts of Oxygen in case is even lower then 0.16% after 21 min.

Because diffusion of Oxygen out of water is supported by pumps and by flow of Nitrogen in water as mentioned above, concentration of Oxygen in water is also reduced. Lower concentration of Oxygen reduces the ability to oxygenate aromatic substances because Oxygen is main substrate of oxidation. Lack of main substrate inhibits or slows course of chemical reactions. No chemical substances like antioxidants are added. According to Henrys law Nitrogen in water can be calculated

Before starting coffee machine, opening flap of case which is front side of case is opened like a door. Axis of rotation 34 is shown in FIG. 2. There is a handle 33 to open opening flap as shown in FIG. 2. Then water 5 is filled in water container 29 and ground coffee 18 i coffee is filled in coffee filter 17. A paper filter can be used. Opening flap is opened like a door using axis of rotation 34. Then opening flap is closed and now case 1 is hermetically sealed. Opening flap 33 has a rubber seal. It is not necessary that seal is working in a 100% way. Over pressure in case 1 permits invasion of Oxygen out of air in case. Then, over-pressure valve at outlet of air out of case 31 is adjusted 0.3 atm is recommended to produce de-oxinated nitrogen-charged coffee, but a low over-pressure of 0.1 atm is possible too.

Then valve for nitrogen at Nitrogen gas cylinder 11 is opened. A typical Nitrogen gas cylinder has a volume of 80 liter and a pressure of 150 bar. So 120000 liter of nitrogen are available in a cylinder. A flow rate regulater at gas cylinder 11 is set up to a flow-rate of 8 liter per minute. after pressure inside case increases, flow rate might decline. So 3 min after starting coffee making device, flow rate has to be checked again and eventually, flow rate has to be adjusted to 8 liter/min.

Case 1 is made of metal or plastic and can resist against a pressure of at least 1 atm. Nitrogen gas cylinder is already connected to case using tube 12 and tube is under pressure because valve of nitrogen bottle is open. No nitrogen gas flows in case because electrically controlled opening valve for Nitrogen 42 is shut when machine is not working.

Next, on/off switch 48 for coffee making device is turned on. Now electronic control 24 of machine transfers control commands to electrical equipment in case 1, having different effects, named A,B,C,D,E, F as described below. There are several pumps inside case. They have different functions. They enable reduction of Oxygen concentration in water by using a diffuser or a faucet, they mix air in case and coffee container, they remove air containing Oxygen out of pipe which is used for hot water They have at a later time, they pump hot water to filter, finally they pump coffee out of coffee container All electric pumps which are used are mini diaphragm pumps, which don't need lubrication.

These are the effects after starting coffee making device by turning on on/off switch for coffee making device

Effect A:

Electromagnetic opening valve for air at out-flow out of case 54 will be closed. Outflow of air is now only possible using outlet of air out of case having an adjustable over-pressure valve 31. This is a relief valve. The relief valve was adjusted before. At least an over presssure of 0.1 atm should have been adjusted, to avoid any inflow of air in case there are leaks. There might be small leaks. For example at the point where tubes are leading in the case or at the opening flap. If there are leaks, no air containing 21% Oxygen can invade case. An adjusted over-pressure of 0.3 atm was already recommended before. If pressure in case is now higher then 4.3 psi, equivalent to 0.3 bar, valve 31 opens. This has the effect that coffee brewing at a later time is made under an over pressure of 4.3 psi, caused mainly by Nitrogen. Such a small pressure is recommended for serving Nitrogen coffee. So coffee is charged with nitrogen giving a better taste, while concentration of Oxygen, leading to a hasty premature oxidation of aromatic substances is heavily decreased.

Effect B:

When on/off switch for coffee making device 48 is turned on Electrically controlled opening valve for Nitrogen 42 opens. Nitrogen gas flows in case using tube 12. This tube leads Nitrogen gas in water container and Nitrogen is drawn in diffuser for nitrogen 15. Type of diffuser is mentioned before. As a result small Nitrogen bubbles escape upward and finally appear on the surface of the water in the water container. While escaping upward, diffusion takes place. Water which was used to fill water container had been in contact to air, having 78% Nitrogen, before. So concentration of dissolved Nitrogen in water is 78% of maximal solubility for Nitrogen, according to partial pressure of Nitrogen in water which is 78% of atmospheric air pressure. So according to diffusion, Nitrogen gas, coming from diffuser is dissolved in water. On the other side dissolved Oxygen in water diffuses in Nitrogen gas bubbles, containing no Oxygen when leaving diffuser. So concentration of nitrogen in water is increased while concentration of Oxygen in water is decreased.

Bubbles appearing at the surface don't contain 100% Nitrogen any more because diffusion has taken place but Nitrogen concentration in these bubbles is soon higher then atmospheric 78%. So minute for minute air inside case 1 is changed into an Nitrogen-Oxygen mixture containing more and more Nitrogen and containing less and less Oxygen. These bubbles appearing at the surface lead to an increase of gas pressure in case. After reaching adjusted pressure of 4.3 psi equivalent to 0.3 bar, relief valve opens and excessive nitrogen-Oxygen mixture leaves case. Relief valve hinders that pressure in case is getting lower then adjusted 0.3 atm. This higher pressure of nitrogen-Oxygen mixture in case increases nitrogen concentration in water too, because concentration of nitrogen is not only dependent on partial pressure which is, increasing more and more to nearly 100%, but also depends on gas pressure of nitrogen-Oxygen mixture which is 0.3 bar (4.3 psi) higher then then atmospheric gas pressure of 1 atm as evident.

Effect C:

When on/off switch 48 for coffee making device is turned on, Electronic control 24 of machine turns on gas pump 30. This gas pump is inside the case and aspirates nitrogen-Oxygen mixture out of case 1, using suction and inlet for nitrogen oxygen mixture 3 and pumps this gas mixture in water of water container using tube 32. at the outlet of tube 32 is a diffuser 9. No additional Nitrogen is needed.

Effect D

When on/off switch 48 for coffee making device is turned on, Electronic control 24 of machine turns on gas pump 19. This gas pump is inside the case and aspirates nitrogen-Oxygen mixture using suction and air inlet 13 leading to electric gas pump 19 and pumps this gas mixture in coffee container using tube 14. Finally nitrogen/oxygen mixture flows in empty coffee container 14 using outlet for Nitrogen oxygen mixture 25 Coffee container is still empty, but there is still air having 21% Oxygen in coffee container. This flow of nitrogen-Oxygen mixture in coffee container increases Nitrogen in coffee container more and more.

Effect E:

When on/off switch 48 for coffee making device is turned on, Electronic control 24 of machine turns on water pump 26. This water pump is inside the case and aspirates water of the water container using Suction and water inlet leading to water pump 7. Then water flows in tube 8 to pump 26. after passing the pump, water flows in tube 20 and then water is running to faucet aerator 10 for reducing dissolved Oxygen in water and increasing dissolved nitrogen in water Faucet is above water level 53 of water container 29, so water drops are passing nitrogen-Oxygen mixture inside case. Minute for minute this nitrogen-Oxygen mixture contains less Oxygen. So diffusion takes place. Partial pressure of Oxygen in water is 0.21 at the beginning. So Oxygen diffuses from water to nitrogen-Oxygen mixture and vice versa nitrogen diffuses in water after starting Nitrogen flow.

Effect F:

When on/off switch 48 for coffee making device is turned on, Electronic control 24 of machine turns on gas pump 50 and simultaneously electromagnetic valve 55 will be shut. This valve is shown in FIG. 3. When electromagnetic valve 55 is shut, gas pump 50 can not suck water out of water container. water pump 4 could be flown through in a passive way. This effect is not intended and this effect is prevented by shutting valve 55. So Electromagnetic valve 55 shuts water outlet of pump 4. Gas pump 50 uses tube 16 to suck nitrogen-oxygen mixture and is leading this nitrogen-oxygen mixture into water container, using tube 6. Tube 6 is used to introduce hot water out of water container in opposite direction at a later time. Pump 4 is not working yet. FIG. 3 showing arrows describes in which way gas pump 50 is working. Before water pump 4 pumps hot water out of water container, tube 16 and tube 6, both filled with air or water are containing an amount of Oxygen in air or water. Gas pump 50 has the effect to flush these tubes with Nitrogen-oxygen mixture containing less and less Oxygen.

Time interval for Nitrogen inflow has been adjusted before starting coffee-making device. A time of 21 min is recommended. After this time is reached, Electronic control 24 of machine turns off all electric pumps 26,30,50,13—this was Effect C,D,E and F as mentioned before and also inflow of Nitrogen, this was Effect B is stopped by shutting opening valve for Nitrogen 42. Also electromagnetic valve 55 is opened again. Simultaneously heater for water 2 is turned on using control line for heater and signal of temperature sensor 36. Heater has a high Voltage wire for heating 51, This wire is running directly out of case, as shown in FIG. 4. Water is heated up to 196 degrees Fahrenheit (91 degrees Celsius). This temperature is recommended for brewing coffee. Using a 4000 Watt heater, it takes about 7 min to heat up water having 20 degrees Celsius to 91 degrees Celsius. Signal of water temperature is registered by temperature sensor 49 beside heater. Signal is transferred to electronic control of machine using power supply and control line for heater and signal of temperature sensor 36. When temperature of water is 91 degrees Celsius, electronic control turns off heater. Heater has an overheating protection. While heating water, air bubbles containing nitrogen and Oxygen start to form and go up, because solubility for Oxygen and nitrogen is lower in heated. The water can not hold the dissolved gas with increased temperature. The water is deaerated This well known effect reduces Oxygen concentration in water too.

After water is heated up to 91 degrees Celsius, electronic control turns off heater and electronic control opens again electrically controlled opening valve for Nitrogen 42. as described as effect B. for 2 minutes. This will reduce oxygen concentration inside case again, After said 2 min Electrically controlled opening valve for Nitrogen 42 is shut

If the water temperature gets lower then 87 degrees Celsius after heating up water, electronic control starts heater again. So electronic control works as a thermostat for water temperature in water container too.

After said 2 min inflow of Nitrogen has ended, electronic control now starts water pump 4 to suck hot water out of water container using tube 6. Simultaneously valve 56 will be shut. This valve is at the inflow of gas pump 50 So hot water cannot flow through gas pump 50 in a passive way. Electromagnetic valve 55 inhibiting the outflow of water out of water pump 4 was already opened at the time when all pumps were turned off by electronic control as mentioned before. Water pump 4 pumps hot water out of water container to filter 17 using tube 16 Filter 17 is filled with ground coffee 18. Hot water finally running in tube 16 flows in filter for filtering ground coffee. Filtering takes place in a well known way. Brewed coffee flows in coffee container 43

5 minutes after starting hot water pump 4, electronic control turns off water pump 4, because all water has been pumped to filter. Then Electronic control turns on indicator lamp 48 to show that brewing coffee is finished. Pump 4 pumps 1 liter water in 1 minute. If filtering of ground coffee takes longer then expected and water in filter had produced an overflow of water when device has been used, then flow rate of pump 4 must be reduced before starting coffee making device again and time for pumping hot water must be extended by reprogramming electronic control 24

Brewed Coffee can be kept in coffee container 43 for several hours. Oxygen concentration is widely reduced in coffee. On request coffee—can be poured out by turning on coffee pump 21. by using switch 48. and by opening spigot at outlet for coffee 27, Coffee pump sucks coffee out of coffee container. When coffee pump is turned on, coffee flows from coffee container in tube 28 leading to coffee pump, then coffee flows to coffee pump 21, then coffee flows in tube 22 leading to the outlet for coffee. Finally coffee pot 23 is filled. Switch for turning on coffee pump is at the outside of case, Stopping outflow of coffee happens in inverse order by turning off coffee pump using switch 48 and by shutting spigot. 27.

If pressure inside case is lower then 0.1 atm for any reason then electronic control 24 opens valve 31, for 2 minutes. This will lead to a new inflow of Nitrogen for 2 min.

when all coffee is poured out, on off switch of coffee making device has to be turned off. Then Electromagnetic opening valve for air at out-flow out of case 54 opens and case is connected to air again. Over pressure decreases to atmospheric level. Simultaneously valve 56 will be opened. This valve is at the inflow of gas pump 50. Electromagnetic valve 55 inhibiting the outflow of water out of water pump 4 was already opened at the time when all pumps were turned off by electronic control as mentioned before. Also All other devices inside case are turned off too and opening flap can now be opened. to remove used ground coffee.

FIG. 2 shows how case can be opened using handle of opening flap 33. Axis of rotation 34 is shown.

FIG. 3 shows in which way electric devices inside case are connected to electronic control

There is a heater for water 2 inside water container 29, beside heater there is a temperature sensor 49. Heater has a power supply of its own, power supply for heater 110V/220V, 51. There is a control line for heater and signal of temperature sensor, 36 There is an electric water pump 4 pumping heated water to coffee filter, There is a electric gas pump 50 beside water pump 4. Both pumps are using the same tubes as described. Number 38 shows power supply and control line for electric water pump 4 for gas pump 50, for Electromagnetic opening valve 55 at outlet of water pump Number 4. and for Electromagnetic opening valve 56 at the inflow of gas pump 50, There is an electric gas pump 19, having a power supply and control line for electric gas pump, 39. There is a electrical coffee pump, 21 having a power supply and control line for electric coffee pump 40. There is an Electronic control of coffee making device 24, having switches, indicator lamp and time controls of electronic control 48. This electronic control has a power supply 110V/220V for electronic control of machine and for electricity consumers in machine 41. There is an electric water pump, 26, having power supply and control line for electric water pump, 35. There is a electric gas pump, 30 having power supply and control line for electric gas pump 37. There is a Electrically controlled opening valve for Nitrogen 42, having a, power supply of Electrically controlled opening valve for Nitrogen, 44

There is a manometer inside case 45, connected with electronic control by control line for signal of manometer, 46. There is a Electromagnetic opening valve for air out-flow out of case 54, connected with electronic control by control line for electromagnetic opening valve, 47.

FIG. 4 describes gas pump 50 and water pump 4 using the same tubes at different times. Also electromagnetic valves are described. In [38] and [39]

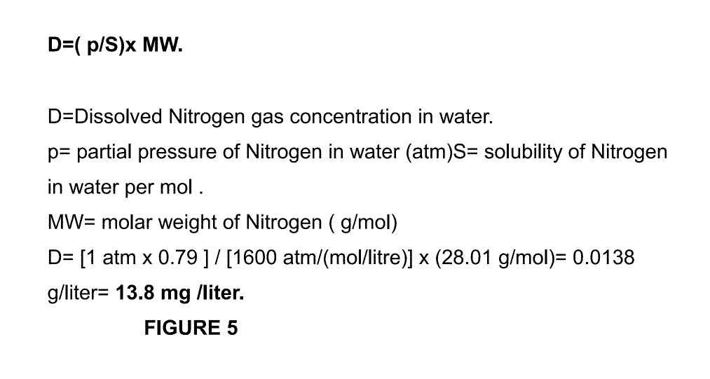

FIG. 5 shows formula for dissolved nitrogen in water

What is claimed is:

1. a coffee making device, comprising
having a case which can be hermetically sealed against an inflow of air, comprising a closable opening flap to fill in water and ground coffee, said case is able to resist against an over pressure of at least 0.7 atm, said case having a inlet for nitrogen, a inlet for power supply, an outlet of air and an outlet for coffee, on/off switches for coffee making device and for coffee pump at the outside of the case, an adjustable time control controllable from outside, an indicator lamp, —having a nitrogen cylinder with a flow control outside of case, —having an electrically controlled electromagnetic opening valve for nitrogen at the inlet of nitrogen in case, having a tube connected to said nitrogen cylinder with flow control, leading to said inlet of nitrogen in case and then leading inside case to water container: Said tube is connected to a diffuser at the end of said Nitrogen tube to form small Nitrogen bubbles in water, reducing dissolved Oxygen in water and charging water with Nitrogen by diffusion. —Having an Electrically controlled electromagnetic opening valve at outlet for air out of case. —Having an adjustable over pressure valve, preventing reflux of air in case and maintaining adjusted over pressure in case to to avoid any influx of air containing 21% Oxygen, to avoid leaks, to charge water with nitrogen when a higher over-pressure had been selected, —Having a gas pump which pumps air out of case inside empty coffee container, mixing Oxygen reduced air out of case with air in coffee container. —Having a heater for water inside coffee container heating water before brewing is started. —Having a temperature sensor inside water container. —Having a water container inside case, said container Having a cover to cover water container, —Having a filter for ground coffee inside case. —Having a coffee container in case. Having an electrically water pump inside case. Said pump Having a tube for leading water out of water container to a pump, Having a tube for leading water out of pump to to faucet aerator above water level for reducing dissolved Oxygen and increasing dissolved nitrogen. Having a an electrically gas pump which has a suction and inlet for gas, which is connected to tubes, pumping nitrogen enriched air inside case into water of water container, Having a diffuser at the end of tube to form small bubbles in water of water container. Having an electric gas pump which is in parallel arrangement to hot-water pump. —Having a tube leading to filter and Having a tube leading to water container which are used by pumps in parallel arrangement to pump hot water out of water to filter or to pump nitrogen—oxygen mixture out of case in water container before pumping water to flush tubes. Said pumps in parallel arrangement Having electromagnetic valves at inflow or outflow of each pump to inhibit that one of these pumps is not flown through in a passive way when the other pump is working. —Having a low voltage power supply and a control line for all low voltage electric devices inside case such as, temperature sensor, electric gas pumps, electric water pumps, electric coffee pump, manometer, electromagnetic opening valve for inlet of nitrogen and electromagnetic opening valve for hot water pump and electromagnetic opening valve for gas pump. Having a 110V/220V power supply for electronic control of machine and for heater in machine, —Having a electrical coffee pump, Having a tube leading from coffee container to coffee pump, Having a tube connecting coffee pump with the outlet for coffee, said outlet Having a spigot, Having a coffee filter, Having Grounded coffee in filter, Having an outlet for coffee, Having a tube for water leading to electric water pump for filtering coffee, Having an electric water pump, pumping heated water to coffee filter, said pump Having a tube for hot water leading to filter, Having an on off switch to start electrically coffee pump to pump coffee in cup on request. —Having an electronically control which has an on off switch for coffee making device, an on off switch for coffee pump, an adjustable time control and an indicator lamp. said control is programmed in this way that in step 1 after starting coffee making device using on off switch said electromagnetic valve for Nitrogen is opened to lead Nitrogen in water of water container, said electronic control having the effect that said 3 electrically gas pumps as mentioned above are started bringing a, Oxygen reduced air in water of water container, by this charging water with nitrogen and removing dissolved Oxygen and b bringing Oxygen reduced air in tube which is used for hot water in step 2 and c pumping air taken from air inside case in empty coffee container, mixing air inside case, Having the effect that after an adjusted time-21 min as recommended—has passed said 3 electric pumps are stopped, the inflow of Nitrogen is stopped by shutting electromagnetic valve for Nitrogen and Having the effect that the heater for water is turned on after adjusted time for reducing Oxygen has passed and Having the effect that after heating water to 91 degrees heater is turned off . . . . Said electronic control has the effect to stop said 3 gas pumps as mentioned before and to stop water pump Having a faucet aerator as mentioned before. Said electronic control has the effect after finishing step 1 to introduce nitrogen again in water for 2 min by opening electromagnetic valve for nitrogen inflow and then starting electric pump for hot water, leading hot water to filter for brewing coffee in a typical well known way. Said electronic control starts flow of Nitrogen again for 3 min by opening electromagnetic valve if pressure inside case is under 0.1 atm caused by a leak. Said electronic control has the effect to start electric coffee pump, pumping coffee out of case when on off switch is turned on and when spigot is turned on. Said electronic control Having a transformer to generate low voltage which is used for low voltage electric devices in case. —Having a manometer inside case Having the effect that said electronic control stops flow of nitrogen if a pressure of 0.7 atm is reached and said control then opens electromagnetic opening valve at outflow of air out out of case to reduce a dangerous high pressure of gas inside case, in case over-pressure-valve does not work in correct manner. —Having a electrical water pump for hot water which pumps hot water to filter to brew coffee in typical way several minutes after starting coffee making device, controlled by electronic control whereby this time can be regulated from outside case, whereby a time of 21 min is the preset value allowing an inlet of 168 liter of nitrogen, using a flow rate of 8 liter Nitrogen per minute from gas cylinder in case before brewing coffee and leading to a massive reduction of dissolved Oxygen in water and leading to a a massive reduction of Oxygen concentration in case, by this reducing ability that high sensitive aromatic substances are oxidated in coffee after brewing coffee while coffee is stored in container.

2. a method of brewing coffee using a coffee making device comprising:
using a hermetically sealed case, widely reducing Oxygen in air inside case of coffee making device by introducing nitrogen in case and widely reducing dissolved Oxygen in water for brewing coffee inside case (1) of coffee making device, by speeding up diffusion of oxygen in water into air inside case, by introducing Nitrogen into water, by using a diffuser producing Nitrogen bubbles inside water, by introducing Nitrogen into air inside case, by removing excess of air out of case using an over-pressure relief valve, pumping water out of water container and producing drops of water by using a faucet aerator and bringing these drops back again in water container to speed up diffusion, by mixing air inside case, by introducing air inside case into tubes which are used for hot water at a later time, by enduring all said procedures till oxygen concentration is widely reduced. Then stopping nitrogen inflow in case and stopping said procedures. then Heating water inside water container inside case, then introducing nitrogen again in case, then pumping heated water in filter of coffee making device, brewing coffee, keeping coffee in coffee container inside case till coffee is consumed, using an electric pump to pump coffee out of coffee container, maintaining an over-pressure inside case all the time to inhibit in flow of air.

3. a process of brewing coffee, comprising
using a coffee making device as claimed under (1) but removing oxygen out of water by using another gas like Argon or a mixture of gas like Nitrogen/CO2 for removing dissolved Oxygen out of water, using a vacuum instead of gas inside hermetically sealed case for removing dissolved Oxygen out of water, using a mixer to bring water in contact to oxygen-free environment, using water in which dissolved Oxygen has been removed before by using another process in which dissolved oxygen leaves water to go into surrounding environment by using water in which dissolved Oxygen has already been removed in a process as claimed under (1), (2) or (3) as described, in a process outside coffee making device,
